(19) United States
(12) Patent Application Publication
(10) Pub. No.: US 2016/0344999 A1
(43) Pub. Date: Nov. 24, 2016

(54) SYSTEMS AND METHODs FOR PRODUCING PANORAMIC AND STEREOSCOPIC VIDEOS

(71) Applicant: 8702209 CANADA INC., Montréal (CA)

(72) Inventors: Félix LAJEUNESSE, Montreal (CA); Paul RAPHAËL, Montreal (CA)

(21) Appl. No.: 15/104,216

(22) PCT Filed: Dec. 15, 2014
(86) PCT No.: PCT/CA2014/000895

§ 371 Date: Jun. 13, 2016

Related U.S. Application Data
(60) Provisional application No. 61/915,873, filed on Dec. 13, 2013.

(51) Int. Cl. H04N 13/02; G06F 3/01; H04N 13/00; H04N 5/232

(52) U.S. Cl. CPC H04N 13/0242; H04N 5/23238; H04N 13/0239; G06F 3/012; H04N 13/0059; H04N 2213/001; H04N 13/044

(57) ABSTRACT

A system and associated method for capturing panoramic and stereoscopic image data can be utilized to produce panoramic and stereoscopic videos for use in conjunction with suitable virtual reality display devices. The system utilizes a camera arrangement consisting of a plurality of camera pairs positioned to capture a 360° environment. Each camera pair comprises a left-eye camera and a right-eye camera and the camera pair planes of each camera pair substantially parallel to each other. The camera pairs can be arranged in levels of varying heights in order to accommodate a greater number of camera pairs, thereby enhancing the resulting image data. Once the image data has been captured, left and right-eye panoramic videos are generated by merging the corresponding images from each left-eye camera at each time point, and each right-eye camera at each time point. The resulting videos can then be output for panoramic and stereoscopic viewing.

### CROSS-REFERENCE TO RELATED APPLICATIONS

The present application incorporates by reference U.S. Provisional Patent Application Ser. No. 60/750,844 filed on Dec. 13, 2013.

### BACKGROUND OF THE INVENTION

1. Field of the Invention

The present invention relates generally to panoramic and stereoscopic videos and more particularly to systems and methods for producing panoramic and stereoscopic videos.

2. Description of Related Art

Methods for producing panoramas are well known in the field of photography. In an example case, a plurality of pictures, each one covering a limited angle of the field of view and having a part of the picture in common with at least another one, can be merged together via the identification of similar objects in the pictures (for example by minimizing the sum of the square of the difference between pictures). Color and lighting can also be adjusted for each picture. By merging together objects identified as being the same, and by adjusting differences in angles between pictures, as well as differences in color and lighting, a single panorama is produced. In order to minimize artifacts in the panorama, the camera used to take the pictures should be adapted to pivot around its rear nodal point. Moreover, since these panoramas are produced using static pictures which are not taken at the same time, these methods are unable to capture and reproduce moving objects and, of course, are inappropriate for video.

Stereoscopic videographic methods eon also be employed to produce panoramas. In these methods, a stereoscopic image is produced using two images of a scene recorded from two positions that are slightly horizontally displaced. In order to adapt the video capture to human visualization, the separation is closed to the inter-ocular distance (on average, 65 to 70 mm). One of these images is presented to the left eye of the viewer, and the other to the right eye, providing a perception of depth to the viewer. Whereas non-filmed content can be made stereoscopic by computer means, filmed videos need two cameras to be used while filming. Again, these cameras have to be positioned parallel and not too far from each other, and the two resulting video streams may be outputted to each human eye of the viewer (or post-production methods can be used in combination with polarizing 3D-glasses to display alternate left/right pictures to the eyes). In this disclosure, the term “film” refers to any medium containing motion picture data, such as videotape, digital video files, conventional movie film, and the like.

In a typical stereoscopic video, each eye of the viewer must not see the same image. Accordingly, each frame of the displayed video, or a given part of the frame, must be aimed at a specific eye. To do so, filters can be placed between each eye and the screen. When the image displayed has to be seen by a specific eye, it is displayed either with a given polarization or a given color set. The filter is either a polarizing filter or a wavelength-specific filter and the eye at which the frame or part of frame is not aimed does not see it. Other types of filters may be used, such as active shutters which are externally activated to block images for one eye at a time, in which case the activation is synchronized with the video.

Whatever the post-production method that is used, there is an incompatibility between stereoscopic video and panoramic photography, for at least the following reasons: first because of the non-trivial nature of panoramic picture production for videos (as discussed above), second, because the use of a pair of cameras impedes pivoting around the nodal point of the camera (because both nodal points, for each camera in the pair, do not coincide), and third, because dealing with panoramic and stereoscopic equipment involves the use of many cameras which have to be positioned in a confined space.

While computer generated hemispheric environments with stereoscopic effects are readily and routinely created for video games which are suited for being played with head-mounted display devices, namely virtual-reality (VR) displays, in order to produce a 360° panorama by filming an environment, fusion of panoramic and stereoscopic imaging poses both depth plane inconsistency and a scene dynamics dilemma wherein the filmmaker must capture both near and far depth plane information from two distinct points in space, along every possible direction over 360° field of view. A head-mounted display VR device of the prior art variety generally takes the form of a screen or a double screen that is placed in front of the eyes of a viewer and held in place by some attachment means such as a headband. Some display devices include side elements that enclose the space between the screen and the viewer's face, so that the head-mounted display device may look like a visor or a mask for scuba diving, except that the glass part is replaced by a screen.

Some display devices use two screens, each one of them being positioned in front of an eye. Other display devices divide the screen in two sections so that each eye sees only the section that is aimed at it. Thus, each eye sees its own video (and there is thus no need to use filters). Lenses, mirrors or other optical elements can be added to the design to ease the eye focus on the screen that is close to the eyes, or to make sure that each eye only sees the appropriate screen or screen portion.

In the video game industry, three-dimensional environments are often created for the purpose of enhancing game-play. By adding artificial stereoscopic effects, head-mounted display devices can be used to play these games with a more interesting experience for the gamer. For example, when the gamer turns his head to the right, he sees what is on the right. Panoramic viewing inherent to the large screens of display devices are easy to produce because the 3D environments of video games already exist. However, in order to produce panoramas by filming real environments, the incompatibility between techniques used to provide panoramic features and those that are used to provide stereoscopic effects have generally confined the use of head-mounted display devices to video game applications. Accordingly, there is a need for a novel system and method for producing stereoscopic and panoramic video content.

### SUMMARY OF THE INVENTION

A system and associated method for capturing panoramic and stereoscopic image data can be utilized to produce panoramic and stereoscopic videos for use in conjunction with suitable display devices, such as head-mounted virtual reality displays. The system utilizes a camera arrangement consisting of a plurality of camera pairs positioned to capture a 360° environment. Each camera pair comprises as left-eye camera and a right-eye, camera and the camera pair planes of each camera pair substantially parallel to each other. The camera pairs can be arranged in levels of varying heights in order to accommodate a greater number of camera pairs, thereby enhancing the resulting image data. Once the image data has been captured, left and right-eye panoramic videos are generated by merging the corresponding images from each left-eye camera at each time point, and each right-eye camera at each time point. The resulting videos can then be output for panoramic and stereoscopic viewing. In one embodiment, a camera arrangement for filming videos enabled for stereoscopic and panoramic effects, includes a plurality of camera pairs, each one of the plurality of camera pairs comprising as left-eye camera and a right-eye camera, and each one of the left-eye cameras and each one of the right-eye cameras having a longitudinal axis, whereby the longitudinal axis of the left-eye camera and the right-eye camera of a given camera pair define a camera pair plane for each one of the camera pairs, wherein each one of the camera pair planes is substantially parallel to each other. In another embodiment, a method for producing a video enabled for stereoscopic and panoramic effects, comprises the steps of filming using a plurality of camera pairs, each one of the camera pairs comprising a left-eye camera and a right-eye camera, for each one of a plurality of time steps, generating a left-eye panorama by merging the images from each one of the left-eye cameras at the each one of the plurality of time steps and a right-eye panorama by merging the images from each one of the right-eye, cameras at the each one of the plurality of time steps, and outputting a left-eye video stream comprising the left-eye panoramas at the plurality of time steps and a right-eye video stream comprising the right-eye panoramas at the plurality of time steps, for display on a device enabled for panoramic and stereoscopic viewing.

### BRIEF DESCRIPTION OF THE DRAWINGS

Further features and advantages of the present disclosure will become apparent from the following detailed description, taken in combination with the appended drawings, in which:

FIG. 1 illustrates a top plan view of as pair of cameras for stereoscopic video filming, in accordance with one embodiment of the present invention;

FIG. 2 shows a perspective view of an exemplary camera embodiment suitable for use in a camera arrangement, in accordance with one embodiment of the present invention;

FIG. 3 depicts an exemplary sound recording system with a plurality of microphone pairs;

FIG. 4 illustrates a top plan view of an arrangement of camera pairs for stereoscopic and panoramic video filming, in accordance with one embodiment of the present invention;

FIGS. 5A, 5B, 5C and 5D are respectively front, rear and side elevation views and a top plan view illustrating an arrangement of camera pairs for stereoscopic and panoramic video filming, in accordance with one embodiment of the present invention;

FIG. 6 is a flow diagram of an exemplary method for producing a stereoscopic and panoramic video, in accordance with one embodiment of the present invention;

FIG. 7 is a flow diagram of an exemplary method for producing a stereoscopic and panoramic video, in accordance with one embodiment of the present invention; and

FIG. 8 is a block diagram of an exemplary computing environment in which the embodiments of the present invention may be implemented.

It will be noted that throughout the appended drawings, like features are identified by like reference numerals.

### DETAILED DESCRIPTION

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

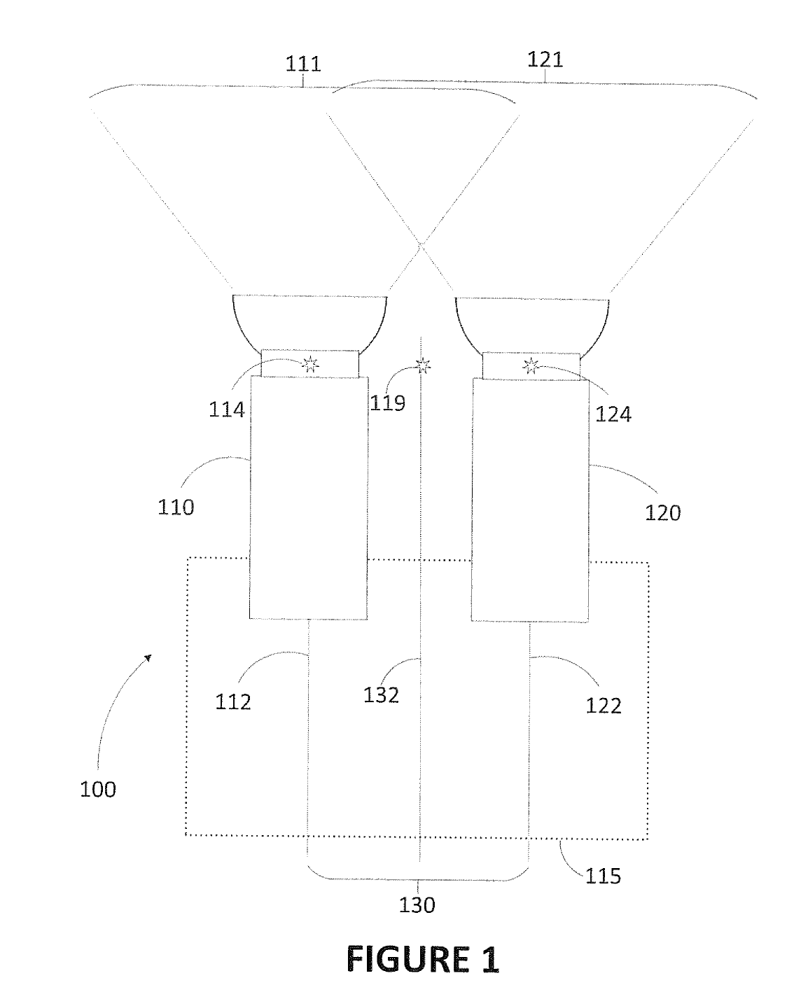

Referring to the drawings, and initially to FIG. 1, there is shown a pair of cameras (or camera pair), indicated generally by reference numeral 100, for use in stereoscopic video filming, in accordance with an embodiment of the present invention. Typical methods for producing videos for watching in 3D imply the use of cameras in a pair. The camera pair 100 of FIG. 1 comprises two cameras 110, 120, each camera for producing images that are associated with each eye of the viewer. It is therefore convenient to identify these cameras as a left-eye, camera 110 and a right-eye camera 120, wherein each camera 110, 120 of the camera pair 100 is capable of filming content that will be presented to the corresponding human eye of the viewer (being the left eye and the right eye, respectively).

The left-eye camera 110 is longitudinally oriented along a left-eye camera axis 112, whereas the right-eye camera 120 is longitudinally oriented along a right-eye camera axis 122. In this way, each one of the left-eye cameras and the right-eye cameras have a longitudinal axis, whereby the longitudinal axis of the left-eye camera 110 and the longitudinal axis of the right-eye camera 120 of a given camera pair 100 define a camera pair plane wherein each one of the camera pair planes is substantially parallel to each other. Note that when the images captured by the camera pair 100 are displayed to the viewer, they will convey to the viewer a sense of depth due to the difference in the pictures provided to both eyes and produced by the two cameras 110, 120 of the camera pair 100. This effect, called stereoscopy, requires that the cameras be configured appropriately. Even though the configuration requirements are not absolute, those of skill in the art will appreciate that deviating from them will lead to unrealistic effects, which, in turn, can make for an uncomfortable viewing experience. In accordance, and as described above, in the embodiment shown in FIG. 1, the left-eye camera 110 and the right-eye camera 120 are positioned parallel to one another. In other words, the left-eye camera axis 112 and the right-eye camera axis 122 need to be substantially parallel. Given the strict nature of the term “parallel” in geometry, in the context of the present disclosure, the expression “substantially parallel” describes the configuration in which the axes are not strictly parallel (in a geometric sense) but more or less appear to be parallel since they differ by a few degrees or less. It should also be understood that both cameras 110, 120 of the camera pair 100 need to point in the same direction, or substantially the same direction.

Still referring to FIG. 1, a central axis 132 of the camera pair 100 is defined as the spatial mean between the left-eye camera axis 112 and the right-eye camera axis 122. The central axis 132 should therefore be parallel, or otherwise substantially parallel, to both the left-eye camera axis 112 and the right-eye camera axis 122. The left-eye camera axis 112 and the right-eye camera axis 122 define a camera pair plane 115 in space. This plane 115 further contains the central axis 132.

The left-eye camera 110 and the right-eye camera 120 are positioned side-by-side, with a spatial separation between them (defined as a camera lateral offset 130) should therefore be substantially constant along the central axis 132.

The value of the camera lateral offset 130 (i.e. the distance between the cameras 110 and 120) can be based upon the mean inter-ocular distance for the human species. The closer the camera lateral offset is to the lateral distance between the viewer's own eyes, the greater the realism and depth sensation of the video to the viewer. The average distance between the centers of the eyes of a human is about 6.5 cm (If the camera lateral offset 130 is around this value, the final video will display more realistic depth effects). Other values of the camera lateral offset 130 can be used if distortions or special effects are desired, for example, for artistic purposes.

Each one of the left-eye camera 110 and the right-eye camera 120 films its own field of view, respectively a left-eye field of view 131 and a right-eye field of view 121 (each field of view is generally indicated in FIG. 1). Normally, both fields of view partially overlap (as further indicated in FIG. 1). Objects that are positioned at the extreme left and at the extreme right are normally viewed only in the left-eye field of view 111 and the right-eye field of view 121, respectively. Objects that are positioned in and around the center (i.e. the portion where the fields of view 111, 121 overlap) are present in both fields of view 111, 121 but are viewed from different angles because both cameras 110, 120 do not take images from the same place. The different perspective on the same object from the two cameras is known as parallax.

Each camera 110, 120 is further characterized by a rear nodal point (114, 124) positioned substantially along a longitudinal axis of each camera 110, 120. There are therefore illustrated in FIG. 1, a left nodal point 114 on the left-eye camera 110 and a right nodal point 124 on the right-eye camera 120. A spatial mean of these two nodal points 114, 124 defines an average nodal point, indicated by reference numeral 119. The average nodal point 119 is positioned substantially along the central axis 132. The nodal point of a lens system is usually in the objective or close to the objective.

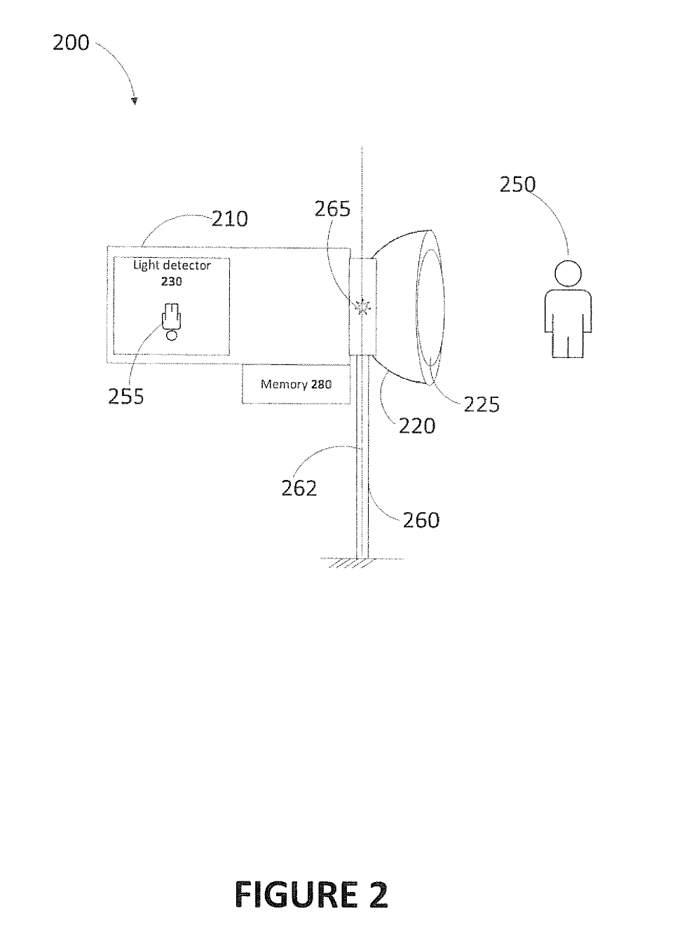

Now referring to FIG. 2, there is shown an example embodiment of a camera 200 suitable for use in the camera arrangements of the present invention. A camera is an object that is well known in the art, and the camera parts detailed herein are presented for information purposes only. In this regard, persons of skill in the art will appreciate that the cameras used in the camera arrangements of the present invention, including the cameras used in each camera pair 100 can take many forms, and need not adhere to the form depicted in FIG. 2.

The camera 200 depicted in FIG. 2 comprises an objective 220 (also known as a photographic objective), which is used for gathering light coming from the objects to the film 250. The objective 220 comprises a lens system 225 for image formation, thereby forming a filmed image 255 from the object to film 250. The image 255 forms on a light detector 230 (for example a charge-coupled device (CCD) or a film, although other technologies may exist). The light receiver is usually in a closed chamber 210 that prevents the surrounding light to cause noisy conditions for the image detector 230.

Since the image 255 that as formed changes continuously, the CCD (or other image receiving device) has to refresh at a given rate and send the accumulated information for one image elsewhere. If a film is used, it has to roll in order to present a different part of the film each time a new image 255 is taken. A memory 280 has to be used for storing the image information at each time step. The film itself or a magnetic cassette can both be a memory, but in the more common cases wherein images 255 are taken by a CCD or other electronic devices, an electronic memory is used. The memory 280 can be in the camera 200, but data may be sent to an external memory.

When the camera is used for panoramic photography or panoramic video, it is better to make sure that the nodal point 265 of the lens system 225 for each configuration to be used is coincident with the nodal point of the original configuration. In this case, it is therefore recommended to allow the pivoting of the camera 200 around the nodal point 265 by mounting the camera on a rig 260 that holds the camera 200 and can pivot around a pivoting axis 262 that crosses the nodal point 265. Small deviations are generally permitted, but alter the quality of the eventual panorama by introducing artifacts in the final product, especially in the stitching areas.

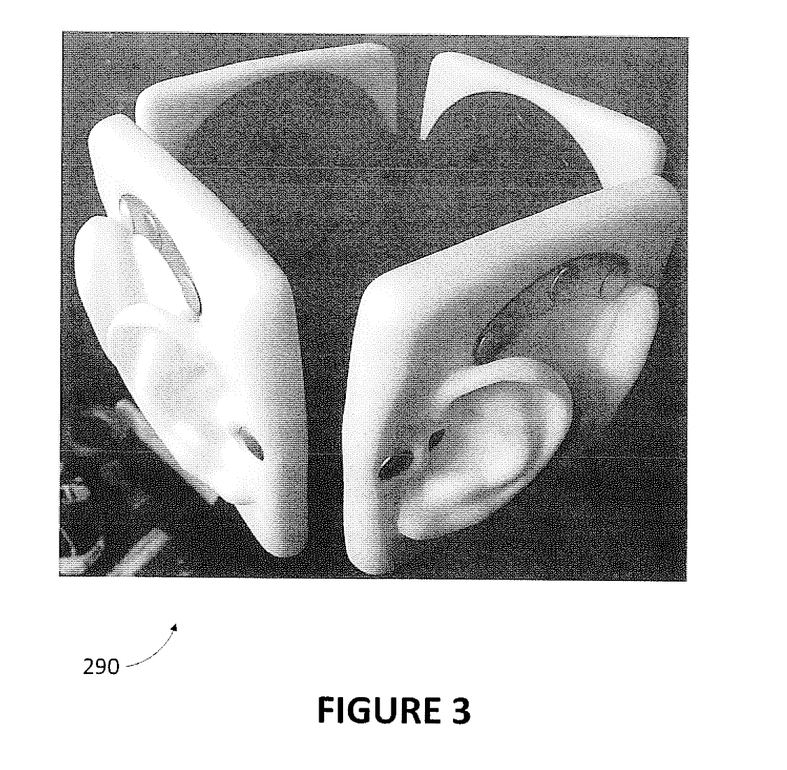

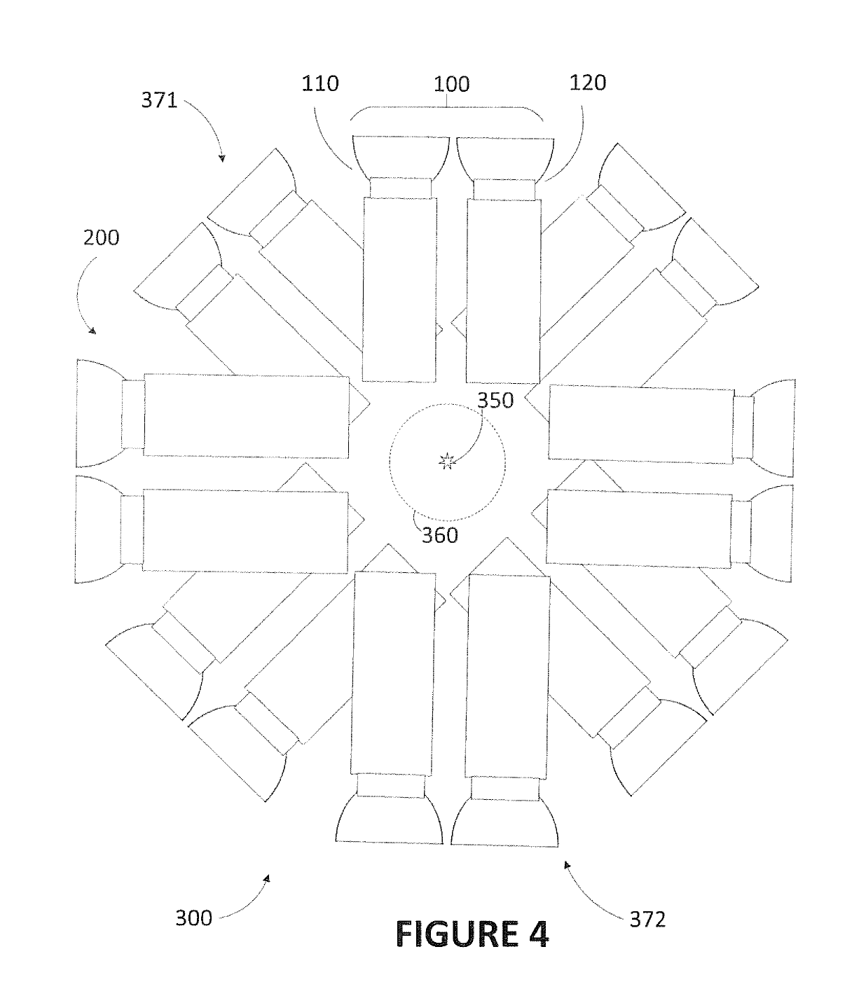

In order to record sound in the environment, a sound recorder can be included either within the camera or outside of the camera, such that the recorded sound can be played along with the video during viewing and wherein the sound is in sync with the images. In this regard, FIG. 3 depicts an example sound recording system with a plurality of ear-shaped microphones in pairs, which could be used to record sound. Still referring to FIG. 3, there is shown a sound recording system 290 adapted for binaural recording, meaning that microphones are placed in pairs. In order to fit with the plurality of camera pairs that is described below in reference with FIG. 4, a plurality of microphone pairs can be provided. In order to reproduce the changes of sound waves occurring at a real ear pinna through diffraction and reflection, the microphones assembled in a pair or in a plurality or pairs can have a shape sculpted as an ear pinna. Such a sound recording system 290, optionally comprises a plurality of microphone pairs positioned in a horizontal plane and having an ear pinna shape, as depicted in FIG. 3. The sound recording system 290 can be placed under the camera arrangement for recording the sound simultaneously while the cameras are filming.

Now referring to FIG. 4, there is shown a camera arrangement 300 for filming images that can be treated to provide both stereoscopic and panoramic features, in accordance with one embodiment of the present invention.

Owing to the dynamic nature of videos (wherein pictures may be taken one after the other for making a panoramic photography, but for video production, this is not possible), in order to merge filmed images together to produce a panorama using the camera arrangement 300 of the present invention, a plurality of camera pairs 100 is employed. As previously indicated, the nodal point 350 of the cameras 110, 120 of each camera pair 100 should substantially coincide in order to minimize artifacts in the panorama.

In order to produce stereoscopic effects, images are captured from a pair of cameras configured substantially as illustrated in FIG. 1. This configuration produces two video streams, each presented to a different eye (or otherwise treated to produce a similar result), to convey depth sensation of a 3D environment to the user. In order to produce stereoscopic and panoramic effects, the system of the present invention utilizes a plurality of camera pairs 100, as depicted in FIG. 4, in a compact arrangement while minimizing artifacts and other defects in the resulting images. Still referring to FIG. 4, a plurality of camera pairs 100 is provided. The camera pairs 100 shown in FIG. 4 are as described above, with reference to FIG. 1. As noted above, each camera pair 100 is characterized by a camera pair plane 115, which is defined as the plane containing the longitudinal axis of each camera 110, 120 in the camera pair 100.

In the arrangement 300, each camera pair 100 has a camera pair plane 115 which is substantially parallel to the camera pair plane 115 of the other camera pairs 100. For example, if a camera pair 100 is horizontal (or substantially horizontal), all camera pairs 100 would have to be horizontal (or substantially horizontal). If a camera pair 100 is inclined, then all camera pairs 100 would have to be inclined in a similar fashion so that the camera pair plane 115 is parallel (or substantially parallel) to the camera pair plane 115 of each of the other camera pairs 100.

As further depicted in FIG. 4, camera pairs 100 can be placed on levels of different heights. In the embodiment shown in FIG. 4, there is shown a first level 371 and a second level 372, wherein the second level 372 is positioned in a horizontal plane above the first level 371. The use of more than one level allows a greater number of camera pairs 100 to be used. Again, while FIG. 4 shows two levels 371, 372, persons of skill in the art will recognize that more than two levels can be used. Further note that owing to the bulky nature of camera pairs 100 compared to the distance of their rear nodal points, only a limited number of camera pairs 100 con be positioned on a single level in a 360° configuration. Using two levels doubles the number of camera pairs (provided that each level comprises the same number of camera pairs). Note that it is preferred that levels not be multiplied or separated by a large distance, because any significant vertical offset between camera pairs 100 can introduce artifacts or other defaults into the resulting image data, Further, it is preferred that the levels coincide with the camera pair plane 115 of their constituting camera pairs—the first level 371 being parallel to the second level 372 (Deviations can exist, but they introduce artifacts or defects into the image data which can be difficult, or even impossible, to correct in post-production).

In accordance with the embodiment shown in FIG. 4, each one of the two levels 371, 372 comprises four camera pairs 100, wherein each camera pair is oriented approximately at a right angle with respect to its neighboring camera pairs 100 on the other level. Because there are only eight camera pairs 100 in the FIG. 4 embodiment, each camera pair 100 has to cover at least 45° (thereby covering a whole circle (360°)) In this regard, note that in the FIG. 4 embodiment, while each of the four camera pairs 100 on the first level 371 is positioned approximately 90° apart, and each of the four camera pairs 100 on the second level 372 is positioned approximately 90° apart, each camera pair 100 on the second level 372 is displaced approximately 45° from the next closest camera pair 100 on the first level 371. If the cameras (and resulting camera pairs) are smaller than the scale shown in FIG. 4, then they can all be placed on the same level (e.g. eight camera pairs (or more) could be placed on the same level).

Still referring to the embodiment shown in FIG. 4, in order to produce image data with adequate panoramic features, instead of having the nodal points of each camera coincide (which is impossible when stereoscopic camera pairs are used), the spatial mean of the nodal point of each camera 110, 120 (of each camera pair 100) has to be close from the spatial mean of the nodal point of each camera in the neighboring camera pair. In other words, the arrangement 300 needs to be compact so that when stereoscopic camera pairs 100 are used, the average nodal point of each camera pair 100 is not too far from the average nodal point 119 of each adjacent camera pair 100.

If viewing substantially above (or below) the horizontal plane is desired, a vertical camera 360 (or pair of cameras) can be positioned above (or below) the center 350 of the arrangement 300. The vertical camera 360 provides images that complete the top of the images in the resulting video (this is important in the event the uppermost camera pairs 100 cannot film completely 180° vertically, The vertical camera 360 does not have to be a part of a camera pair, since in many cases, it is not necessary to introduce stereoscopic effects in this direction (and accordingly, in these cases, a single camera pointing toward upward will suffice).

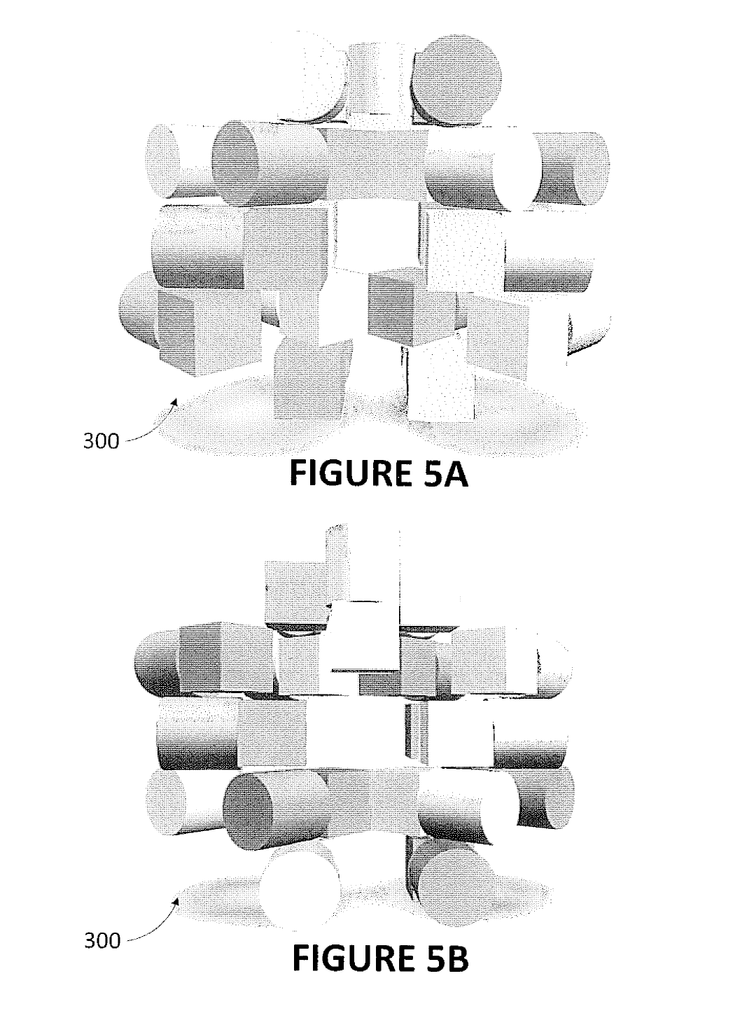

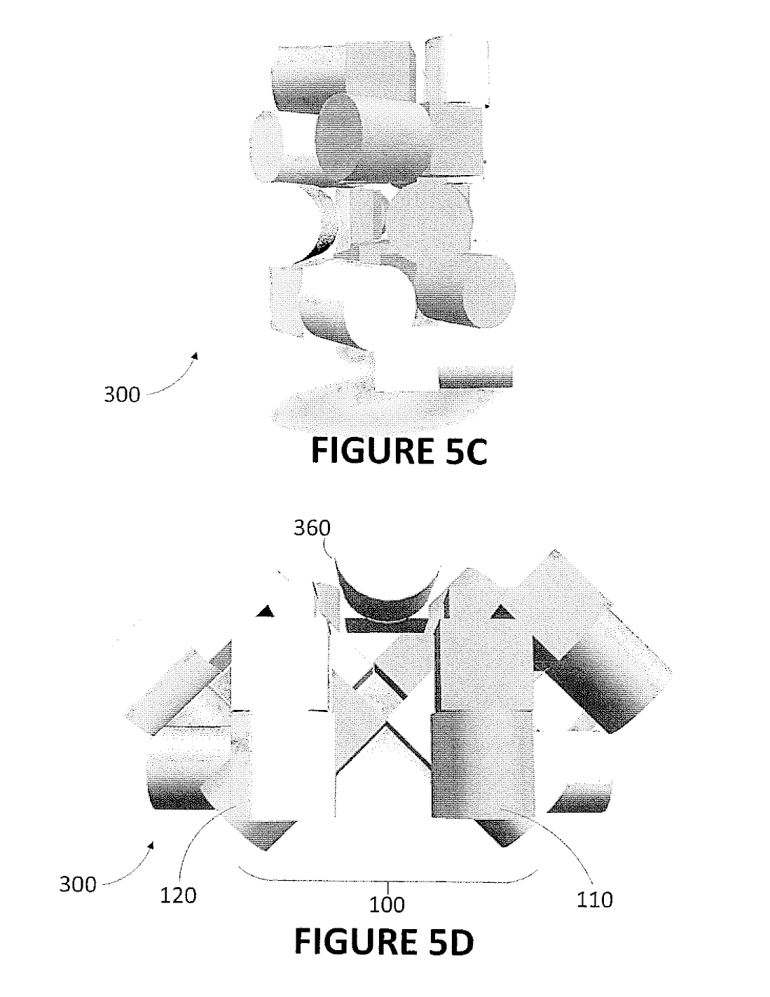

An alternate embodiment of the camera arrangement 300 of the present invention is illustrated in FIGS. 5A to 5D. In the illustrated embodiment, the camera pairs 100, as described above, are arranged in a compact arrangement of five levels.

One would reasonably expect that arranging camera pairs on a high number of levels would be detrimental to the quality of the resulting panoramas since panoramas are advantageously produced from images captured at approximately the same height. However, in the embodiment illustrated in FIGS. 5A to 5D, when the angle of view changes 45°, the view is captured by a camera which is only one level up or one level down and accordingly (end assuming a short distance between levels), the images captured by multiple camera pairs for a given angle of view, are approximately the same height. This feature is the same in the embodiment illustrated in FIG. 4.

Further note that if the environment that is filmed comprises an object that is the principal element of the video, the front portion (illustrated in FIG. 5A) can point toward that object, with only one camera pair 100 being on the upper level and filming in the front direction. When the viewer watches the resulting film (using an appropriate head-mounted display device) in the front facing direction and then turns his or her head right or left away from the principal object, the new view that is displayed has been filmed by camera pairs which were on lower level (since the front direction is filmed by one camera pair positioned at the highest level). Therefore, when the viewer turns his or her head away from the front facing direction, the viewer's viewpoint will orient slightly downward. This is not a disadvantage, since in real life, when people turn their head left or right, they have a tendency to shift their line of signal slightly downward (this is generally accomplished by virtue of the movement of the neck, which has a tendency to shift the angle of it person's head slightly downward when a person turns his or her head left or right).

Referring to FIG. 5D, the single vertical camera 360 is shown, and the central axis 350 (not shown) of the camera arrangement 300 is substantially centered upon the vertical camera 360, as in the FIG. 4 embodiment.

The system of the present invention can accommodate a plurality of camera arrangements, provided that the plurality of camera pairs define a horizontal plane that is substantially parallel with the horizontal plane of other camera pairs (assuming that vertical consistency is important to the filmmaker), and further provided that the average nodal point of a camera pair is not too far from the average nodal point of the neighboring camera pairs (which also means that the difference in the number of levels between neighboring camera pairs is low). The precise camera arrangement will therefore depend on the requirements such as available space (e.g. the need for a compact arrangement) and the need for vertical consistency between camera pairs (i.e. not too many levels, for example if verticality matters, as for environments that contain subjects close to the camera).

An example of a suitable camera for use in the camera arrangement of the present invention is a camera with a small size (such as a 3 cm³ camera). Currently, these small cameras have a resolution of 1920×1080 and as refreshment rate of 60 images/s. Smaller cameras can also be used, but their resolution is generally weaker. Additional considerations to be taken into account when selecting a suitable camera include desired video quality, camera cost, the need for external camera components, such as external lenses and external memory, and the maximum size of the video file, among other factors.

Camera lenses can be adapted to provide a very large field of view (up to 180°). However, the closer to 180° the field of view is, the weaker the resolution in the center of the image is. Accordingly, in order to achieve a better vertical field of view, each camera can be turned from a right angle (approximately). For example, if the camera has a field of view with a horizontal/vertical ratio of 16:9, the vertical and horizontal axes of the view can be interchanged so that the vertical portion of the environment is better captured. In the horizontal plane, the loss of field of view is compensated by the higher number of cameras.

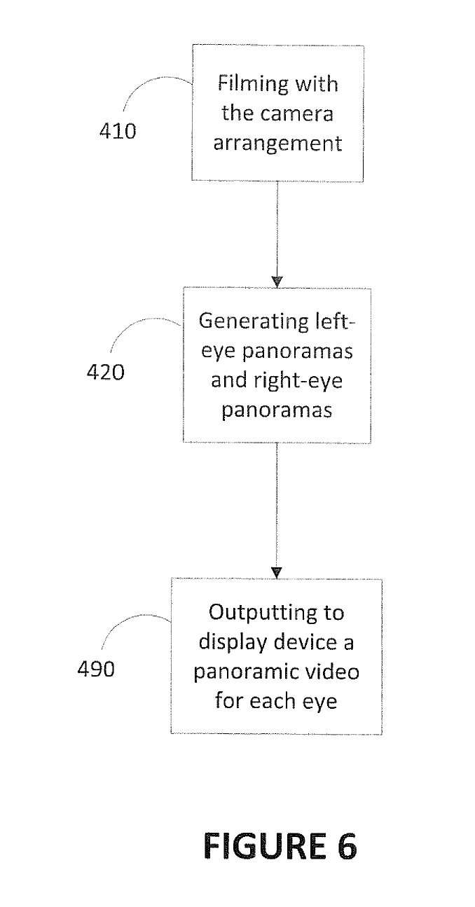

Now referring to FIG. 6, there is shown a flow diagram of a method for producing a stereoscopic and panoramic video using the camera arrangement 300 described above, in accordance with one embodiment of the present invention.

The method depicted in FIG. 6 includes a first step 410 of filming using a plurality of camera pairs arranged in accordance with a camera arrangement defined by the present invention, to produce a plurality of video streams, wherein each video stream corresponds to a particular camera. While filming, the camera arrangement may remain static, or may be moved, depending on the filmmaker's preferences.

After image data has been collected, the second step 420 involves the production of a video having panoramic and stereoscopic effects by generating a left-eye panorama and a right-eye panorama for each lime point (or time step).

For a given time point and a given eye (e.g. left eye), the images taken by the left-eye camera 110 of each camera pair 100 are assembled and merged together using a software tool specialized in panorama generation, in order to produce a left-eye panorama. If the constating camera arrangement 300 is similar to the embodiment shown in FIG. 4, then a full 360° left-eye panorama will result (Conversely, if the camera pairs 100 are arranged such that the combined field of view of the camera pairs 100 is less than 360°, then the resulting panorama will be less than 360°).

The same procedure is applied for the image data produced by the right-eye camera 120 of each camera pair 100 at each time point, thus generating a right-eye panorama. By repeating this procedure for every time point, two panoramic video streams are produced: a left-eye panoramic video composed of a plurality of left-eye panoramas, each panorama corresponding to a given time point, and a right-eye panoramic video composed of a plurality of right-eye panoramas, each right-eye panorama also corresponding to a given time point. Since each panorama is independent, the order in which the panoramas are generated is not critical.

Moving next to step 490, the resulting left-eye and right-eye panoramic videos can be outputted to the head-mounted display device by conventional means for presentation to the viewer, wherein each of the left-eye panoramic video and right-eye panoramic video is presented to the corresponding eye of the viewer. Note that the camera arrangements and method for filming and producing panoramic and stereoscopic videos described herein are compatible with a variety of display devices, provided that the resulting image data is properly converted (as required) to a format readable by the device.

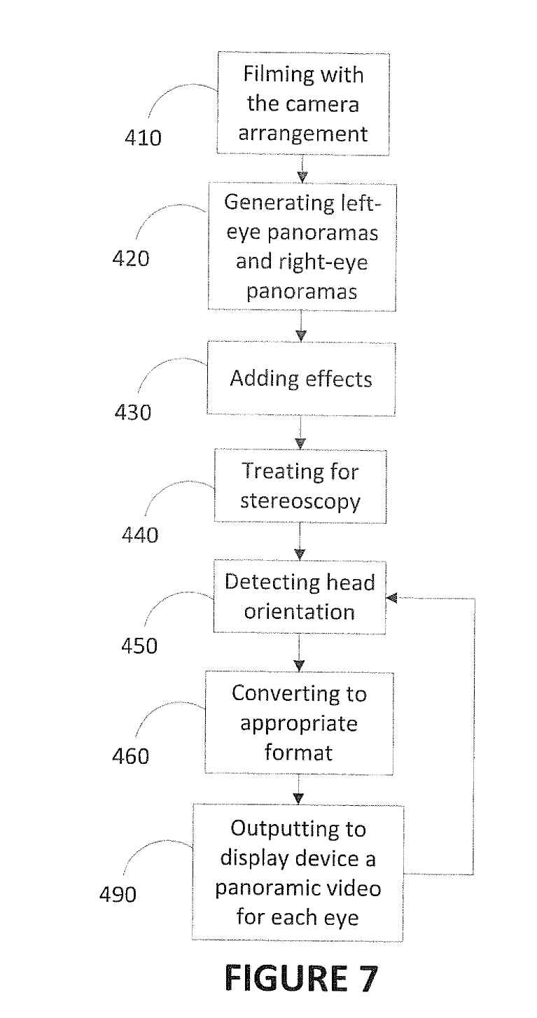

Depending upon the context in which the method described above is implemented, further processing steps may be employed. Now referring to FIG. 7, there is illustrated a multi-step method for generating panoramic and stereoscopic videos based on the base method depicted in FIG. 6. The method depicted in FIG. 7 includes examples of additional processing steps that may be implemented, depending on the computer programs or video post-production techniques employed by the filmmaker. The additional steps described below usually follow the first steps 410 and 420 in which filming and panorama generation are performed.

Still referring to FIG. 7, step 430 consists of adding effects to the video (here, colors, contrast, light and other features of a photographic nature can be changed during this step for improving the video. Special effects can also be produced). The generation of panoramas at step 420 may result in the generation of artifacts (principally owing to the stereoscopic arrangement of the cameras). Correcting these defects can be performed at step 430.

Most head-mounted display devices do not have one screen for each eye, but only one large screen. Therefore, a single video stream needs to be provided to the device (and not separate left-eye and right-eye panoramic videos). Accordingly, in order to be compatible with these types of display devices, the two panoramic videos produced at step 420 have to be treated to generate a single video stream in which stereoscopic effects are provided. In this case, step 440 is performed, which comprises treating the videos for generating stereoscopic effects.

The treatment step 440 can comprise time-based multiplexing, also known as frame sequential multiplexing, in which the left-eye and right-eye images are combined, wherein the eye side of the image alternates for each successive frame of the video (For example, a left-eye panorama is first presented, then right, left, right, and so on). The display device should include means (such as polarizing filters, wavelength-selective filters, IR/radio-activated filters, etc.) to block right-eye panorama of a given frame of the video to be seen by the left eye, and vice versa.

In order to keep a high refreshment rate of the screen for both eyes, frames may be cut in two, thereby presenting half of the screen to the left eye with a part of the left-eye panorama, and presenting the other half of the screen to the right eye with a part of the right-eye panorama (proportions may change). The screen may be divided in two along a horizontal axis (top/bottom multiplexing) or a vertical axis (side-by-side multiplexing). Again, integrated optical filters are used so that each eye of the viewer does not see the panoramas that need to be seen by the other eye, in order to provide stereoscopic effects.

Other techniques exist and should be considered as possible variants of step 440, which basically consist of treating the video to produce 3D effects therein. The software tool Unity™, which usually allows creating video games for 3D applications used by head-mounted display devices, can be used to perform step 440. The head-mounted display device may include an associated software development tool (SDK) that provides specifications of the display device and functions to be used therewith. The SDK can determine the tool to be used to perform step 440 respecting the specifications of the display device in question.

Step 460 comprises converting the video file to a format having characteristics (resolution, refreshment rate of the screen, file structure, file extension, libraries, etc.) that are readable by the display device. For example, the software tool Unity™ can be used to transform the videos outputted in step 420 and modified in steps 430 and 440 into a file that is fully compatible with a given head-mounted display devices (and thereby enabling the functions that such a device could provide). The scale of the video can be modified to match the display device and the distance between the user's eyes and the screen. Distortions can appear and are preferably corrected before display. This can be performed at step 460. Final touch ups can be performed to improve stereoscopic effects (for example, by dealing with discontinuities between frames). Since the video can be hemispheric or even spherical and the viewer can look in a variety of directions, as correction can be brought to the video portion which corresponds to the location of cameras. This patching, which can be performed at step 460, provides an alternative view of the floor under the cameras (e.g. based on the neighboring sections of the images) for replacing the blackout section of the view resulting from the fact that cameras cannot film themselves. Other features can be added to the video, including but not limited to user menus, subtitles, and film transitions.

Patching may be performed by using a static picture of what is found under the camera arrangement 300. Accordingly, after filming, a static picture of what is under the arrangement 300 is taken and merged with the bottom of the images of the video. In combination with the vertical camera, not only is a hemispheric video produced, but a complete spherical video too.

Step 460 can be performed in real time, in which case the input from the head-mounted display device needs to be received to know if the head of the viewer changed its orientation. It also means that the software tool developed for step 460 has to be fast enough so that, at each point (or time step), the head orientation is determined in order to display images accordingly. Step 460 is thus the step which determines which portion of the panoramic/hemispheric/spherical images have to be displayed to the viewer. Sound treatment can be performed at this step too, so that the sound heard by the viewer corresponds to what should be heard if the head was oriented in the same way in the environment that was filmed, based on the sound that was recorded. This is why a sound recording system comprising a plurality of microphone pairs is useful. If it is possible, some tasks described as part of step 460 (like correction of images) can be performed earlier (steps 430 and 440) instead to ensure the best speed of treatment at step 460 which is performed repeatedly.

In this case, it means that step 450, which consists of detecting the head orientation, needs to happen before step 460. Step 450 is thus performed repeatedly in order to select, treat and display the right portion of the panoramic images each time the user moves the head. This repetition is illustrated as a loop in FIG. 7. Detecting the head orientation can also be used when a menu is displayed to select an option of the menu using the head orientation, or to trigger a transition to a particular scene, for example, when the viewer has a head orientation pointing toward a particular object in the video.

Depending on the software products and the display device that is used, steps 430, 440 and 460, or parts of these steps, can be intertwined. In this regard, note that some software products have built-in functionalities that can achieve more than one of the actions that are related to steps 430, 440 and 460, and the order can be modified accordingly.

Once these additions are performed (if they are needed or desired), the final video with panoramic and stereoscopic effects can be displayed to the user with the appropriate device at step 490.

If a vertical camera 360 is used during filming, the video can comprise a spherical representation of the reality, enabling a view of 360° horizontally and 180° vertically approximately, corresponding to viewing in a solid angle of 4 pi steradians approximately. If no vertical camera 360 is used, if no picture of what is found under the arrangement 300 is taken, or if the cameras do not have a 180° vertical field of view, the solid angle which can be viewed is less than 4 pi steradians. If the view is purely hemispheric, the solid angle is only 2 pi steradians. The maximum solid angle for viewing corresponds to what has been filmed.

Videos having the described panoramic and stereoscopic effects may be filmed advantageously during sports events, music shows and other events in which a viewer would appreciate the sensation of being in the action without being physically present. The panoramic and stereoscopic videos may also be used for a realistic contemplation or natural or architectural environments, thereby bringing beauty to the eyes of a viewer along with realistic depth sensations, with no displacement.

Using a suitable head-mounted display device which displays a video produced in accordance with the systems and methods described herein, it is possible to experience the action that is filmed. For example, if a show is filmed by a camera arrangement 300 placed on a stage, users viewing the video using a suitable head-mounted display device would be able to view the show in any direction they wish.

If, for example, the camera arrangement 300 is placed in an interesting building, such as a museum or other tourist attraction, viewers can look in every direction as they turn their head in a given direction. They can see what they want, and they see the movement of visitors around them because they were filmed and not only photographed.

Similarly, if the camera arrangement 300 is placed in the street, viewers wearing the head-mounted display device and watching to the resulting video could view the street as if they were there. Whereas existing tools such as Google Street View™ allow seeing a panoramic hemispheric view of the street, the video produced by the camera arrangement 300 (and treated properly) would allow a user to view a panoramic and hemispheric video (not only a static picture) of the street, in which pedestrians and cars would be moving, additionally providing stereoscopic effects.

If camera arrangement 300 is moving when recording, viewers will have the impression of moving too, with the possibility of looking around them still available. A fully realistic environment can therefore be recorded and displayed to viewers.

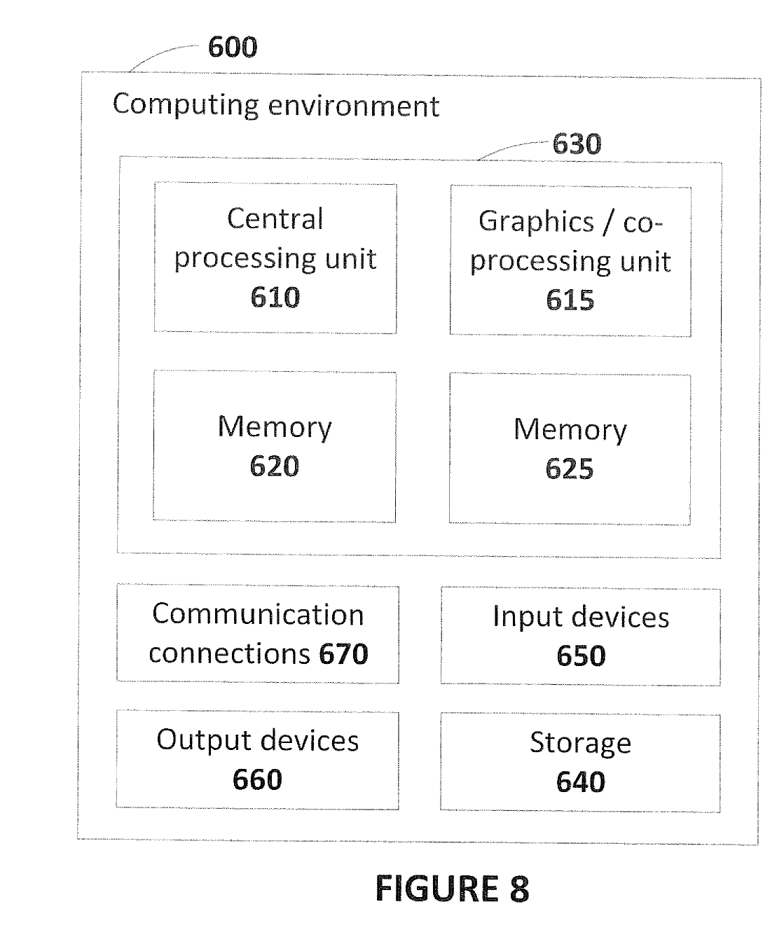

Steps related to panorama generation and multiplexing for stereoscopy are advantageously implemented in a computing environment. FIG. 8 illustrates a generalized example of a suitable computing environment 600 in which the described embodiments of the present invention may be implemented. The computing environment 600) is not intended to suggest any limitation as to scope of use or functionality, as the techniques and tools may be implemented in diverse general purpose or special-purpose computing environments.

With reference to FIG. 8, the computing environment 600 includes at least one CPU 610 and associated memory 620 as well as at least one GPU or other co-processing unit 615 and associated memory 625 (used for example for video acceleration). In FIG. 8, this most basic configuration 630 is included within the dashed line. The processing unit 610 executes computer-executable instructions and may be a real or a virtual processor. In a multi-processing system, multiple processing units execute computer-executable instructions to increase processing power. A host encoder or decoder process offloads certain computationally intensive operations to the GPU 615. The memory 620,125 may be volatile memory (e.g., registers, cache, RAM), non-volatile memory (e.g., ROM, EEPROM, flash memory, etc.), or some combination of the two. The memory (620, 625) stores software 680 for a decoder implementing one or more of the decoder innovations described herein.

A computing environment may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The storage 640 may be removable or non-removable, and includes magnetic disks, magnetic tapes or cassettes, CD-ROMs, DVDs, or any other medium which can be used to store information and which can be accessed within the computing environment 600. The storage 640 stores instructions for the software 680.

The input device(s) 650 may be a touch input device such as a keyboard, mouse, pen, or trackball, a voice input device, a scanning device, or another device that provides input to the computing environment 600. For audio or video encoding, the input device(s) 650 may be a sound card, video card, TV tuner card, or similar device that accepts audio or video input in analog or digital form, or a CD-ROM or CD-RW that reads audio or video samples into the computing environment 600. The output device(s) 660 may be a display, printer, speaker, CD-writer, or another device that provides output from the computing environment 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools can be described in the general context of computer-readable media. Computer-readable media are any available media that can be accessed within a computing environment. By way of example, and not limitation, with the computing environment 600, computer readable media include memory 620, storage 640, communication media, and combinations of any of the above.

The techniques and tools can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

While preferred embodiments have been described above and illustrated in the accompanying drawings, it will be evident to those skilled in the art that modifications may be made without departing from this disclosure. All such modifications, adaptations, or variations that rely upon the teachings of the present invention, and through which these teachings have advanced the art, are considered to be within the spirit and scope of the present invention. Accordingly, these descriptions and drawings should not be considered in a limiting sense, as it is understood that the present invention is in no way limited to only the embodiments illustrated.

We claim:

1. A camera arrangement for filming videos enabled for stereoscopic and panoramic effects, the camera arrangement comprising:
a plurality of camera pairs, each one of the plurality of camera pairs comprising a left-eye camera and a right-eye camera, each one of the left-eye cameras and each one of the right-eye cameras having a longitudinal axis, whereby the longitudinal axis of the left-eye camera and the longitudinal axis of the right-eye camera of as given camera pair define a camera pair plane for each one of the plurality of camera pairs, and wherein each one of the camera pair planes is substantially parallel to each other.

2. The camera arrangement of claim 1, wherein the left-eye, camera and the right-eye camera of each one of the plurality of camera pairs are positioned side-by-side.

3. The camera arrangement of claim 1, wherein each one of the plurality of camera pairs further comprises a central axis which is substantially parallel to each of the longitudinal axis of the left-eye camera and the longitudinal axis of the right-eye camera.

4. The camera arrangement of claim 3, the spatial separation between the left-eye camera and the right-eye camera of each one of the plurality of camera pairs is substantially constant along the central axis.

5. The camera arrangement of claim 4, wherein the value of the spatial separation between the left-eye camera and the right-eye camera of each one of the plurality of camera pairs is approximately 6.5 centimeters.

6. The camera arrangement of claim 1, wherein each of the left-eye cameras and the right eye cameras of each camera pair include a rear nodal point positioned substantially along the longitudinal axis of each camera, and wherein the rear nodal points of each left-eye camera and each right-eye cameras of each camera pair substantially coincide.

7. The camera arrangement of claim 1, wherein the combined field of view of the plurality of camera pairs is 360 degrees.

8. The camera arrangement of claim 1, further comprises an at least one camera having a longitudinal axis which substantially coincides with the central axis, wherein the at least one camera is positioned above the center of the camera arrangement for capturing overhead images.

9. The camera arrangement of claim 1, wherein a portion of the plurality of camera pairs are positioned on a first level, and a portion of the plurality of camera pairs are positioned on a second level.

10. The camera arrangement of claim 9, wherein the first level comprises four camera pairs positioned approximately 90° apart and the second level comprises four camera pairs positioned approximately 90° apart.

11. The camera arrangement of claim 10, wherein each camera pair on the second level is displaced approximately 45° from the next closest camera pair 100 on the first level.

12. A method for producing a video enabled for stereoscopic and panoramic effects, the method comprising the steps of:
filming using a plurality of camera pairs, each one of the camera pairs comprising a left-eye camera and a right-eye camera;
for each one of a plurality of time steps, generating a left-eye panorama by merging the images from each one of the left-eye cameras at the each one of the plurality of time steps and a right-eye panorama by merging the images from each one of the right-eye cameras at the each one of the plurality of time steps; and
outputting a left-eye video stream comprising the left-eye panoramas at the plurality of time steps and a right-eye video stream comprising the right-eye panoramas at the plurality of time steps, for display on a device enabled for panoramic and stereoscopic viewing.
